(19) United States
(12) Patent Application Publication
(10) Pub. No.: US 2018/0324515 A1
(43) Pub. Date: Nov. 8, 2018

(54) Over-the-ear headphones configured to receive earpieces

(71) Applicant: BRAGI GmbH, München (DE)

(72) Inventors: Peter Vincent Boesen, München (DE); Charles R. Quainoo, München (DE); Kaloyan D Sotirov, München (DE)

(73) Assignee: BRAGI GmbH, München (DE)

(21) Appl. No.: 15/946,467

(22) Filed: Apr. 5, 2018

Related U.S. Application Data
(60) Provisional application No. 62/501,039, filed on May 3, 2017.

(51) Int. Cl. H04R 1/10

(52) U.S. Cl. CPC H04R 1/1041; H04R 1/1008; H04R 2420/07; H04R 1/105; H04R 1/1025

(57) ABSTRACT

A set of over-the-ear headphones configured for receiving earpieces, the set of over-the-ear headphones in embodiments of the present invention may have one or more of the following features: (a) a first ear portion, (b) a second ear portion, (c) a headband spanning between the first ear portion and the second ear portion, (d) a first receptacle in the first ear portion for receiving a first earpiece, and (e) a second receptacle in the second ear portion for receiving a second earpiece, a first connector in the first receptacle in the first ear portion for connecting to a first corresponding connector in the first earpiece and a second connector in the second receptacle in the second ear portion for connecting to a second corresponding connector in the second ear piece.

### PRIORITY STATEMENT

This application claims priority to U.S. Provisional Patent Application No. 62/501,039 filed on May 3, 2017 titled Over-the-Ear Headphones Configured to Receive Earpieces, which is hereby incorporated by reference in its entirety.

### FIELD OF THE INVENTION

The present invention relates to wearable devices. More particularly, but not exclusively, the present invention relates to over-the-ear headphones.

### BACKGROUND

Portable listening devices, can be a portable media player, smart phone, tablet computer, laptop computer, stereo system and can be used in combination with a wide variety of electronic devices. Portable listening devices can be placed in or on the ear of the user. One or more small speakers can be configured or placed near the ear to transfer audio to the tympanic membrane of the ear. Structural components hold the speaker within or on the ear. Often there is a cable for transferring the audio from the media player to the portable listening devices. The listening devices can be wireless for wirelessly receiving a stream of audio data from the wireless audio source instead.

While there are many advantages in comparison with wired devices, there are also potential disadvantages for wireless devices. For example, a wireless portable listening device typically requires one or more batteries, such as rechargeable batteries for powering the other components of the wireless communication circuits and devices. Disposable batteries need to be replaced when they run out of power. Rechargeable batteries are not much better as they must be regularly charged. Further, small wireless earphones are easily lost when not in use. Additionally, since the space available in each earpiece is small, achieving high-end acoustic performance from a relatively small earphone is difficult for manufacturers.

It would be desirable to have a case which can accommodate and charge a portable listening device, such as a pair of wireless earphones (earbud) or other types of headphones. It would be further desirable to have one or more features to improve the user experience associated with the use of the case and the portable listening device. It would be desirable to know when the earphone is housed in the case.

Users have an increased desire for a sophisticated listening experience. In addition, users are beginning to appreciate the functionality of hearable devices. One of the problems consumers encounter is choosing between over-the-ear headphones and wireless earpieces. What is needed are better products which address problems of both over-the-ear headphones and wireless earpieces or hearing aids.

### SUMMARY

Therefore, it is a primary object, feature, or advantage of the present invention to improve over the state of the art.

A set of over-the-ear headphones configured for receiving earpieces, the set of over-the-ear headphones in embodiments of the present invention may have one or more of the following features: (a) a first ear portion, (b) a second ear portion, (c) a headband spanning between the first ear portion and the second ear portion, (d) a first receptacle in the first ear portion for receiving a first earpiece, and (e) a second receptacle in the second ear portion for receiving a second earpiece, a first connector in the first receptacle in the first ear portion for connecting to a first corresponding connector in the first earpiece and a second connector in the second receptacle in the second ear portion for connecting to a second corresponding connector in the second ear piece.

A method in embodiments of the present invention may have one or more of the following steps: (a) physically connecting a set of wireless earpieces or hearing aids with a set of over-the-ear headphones, (b) charging the set of wireless earpieces or hearing aids while physically connected with the set of over-the-ear headphones, (c) transferring data between the set of wireless earpieces or hearing aids and the set of over-the-ear headphones while physically connected, and (d) transferring an audio signal between the set of wireless earpieces or hearing aids and the set of over-the-ear headphones while physically connected.

A set of over-the-ear headphones configured for receiving earpieces, the set of over-the-ear headphones in embodiments of the present invention may have one or more of the following features: (a) a first ear portion, (b) a second ear portion, (c) a headband spanning between the first ear portion and the second ear portion, (d) a first receptacle in the first ear portion for receiving a first hearing aid, (e) a second receptacle in the second ear portion for receiving a second hearing aid, (f) a first connector in the first receptacle in the first ear portion for connecting to a first corresponding connector in the first hearing aid and a second connector in the second receptacle in the second ear portion for connecting to a second corresponding connector in the second hearing aid, (g) a cover removable coupled to fit over the first receptacle, (h) a processor, and (i) a recharging interface.

One or more of these and/or other objects, features, or advantages of the present invention will become apparent from the specification and claims follow. No single embodiment need provide every object, feature, or advantage. Different embodiments may have different objects, features, or advantages. Therefore, the present invention is not to be limited to or by any objects, features, or advantages stated herein.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial view of a headphone in accordance with embodiments of the present invention;

FIG. 2 illustrates a pair of over-the-ear headphones which is adapted to receive wireless earpieces or hearing aids in accordance with embodiments of the present invention;

FIG. 3 is a pictorial view of the headphone in accordance with embodiments of the present invention;

FIG. 4 illustrates the pair of over-the-ear headphones with a cover removed to show a recessed area sized and shaped to receive a wireless earpiece or hearing aid in accordance with an embodiment of the present invention;

FIG. 5 illustrates the pair of over-the-ear headphones with a wireless earpiece or hearing aid received within it in accordance with embodiments of the present invention;

FIG. 6 illustrates the set of wireless earpieces in accordance with embodiments of the present invention;

FIG. 7 is a block diagram of one example of a wireless earpiece in accordance with embodiments of the present invention;

FIG. 8 is a block diagram of one example of a pair of over-the-ear headphones in accordance with embodiments of the present invention;

FIG. 9 depicts another example of a pair of over-the-ear headphones in accordance with an illustrative embodiment; and

FIG. 10 shows a flowchart of operation between a wireless earpiece(s) and over-the-ear headphones in accordance with an illustrative embodiment.

Some of the figures include graphical and ornamental elements. It is to be understood the illustrative embodiments contemplate all permutations and combinations of the various graphical elements set forth in the figures thereof

### DETAILED DESCRIPTION

The following discussion is presented to enable a person skilled in the art to make and use the present teachings. Various modifications to the illustrated embodiments will be plain to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of selection and storage of wireless earpieces within over-the-ear headphones, it is fully contemplated embodiments of the present invention could be used in most any aspect of audio devices without departing from the spirit of the invention.

It is an object, feature, or advantage of the present invention to provide improved over-the-ear headphones.

It is a still further object, feature, or advantage of the present invention to provide over-the-ear headphones which interface with wireless earpieces or hearing aids.

Another object, feature, or advantage is to expand the functionality of wireless earpieces or hearing aids through using over-the-ear headphones.

Over-the-ear headphones are provided which are used to receive wireless earpieces or hearing aids. The wireless earpieces or hearing aids may be charged by or through the over-the-ear headphones. In addition, the presence of the wireless earpieces or hearing aids may be used to enhance functionality of the over-the-ear headphones. Similarly, the presence of the over-the-ear headphones may be used to enhance functionality of the wireless earpieces or hearing aids.

According to one aspect, a set of over-the-ear headphones configured for receiving earpieces or hearing aids includes a first ear portion, a second ear portion, a headband spanning between the first ear portion and the second ear portion, a first receptacle in the first ear portion for receiving a first earpiece, and a second receptacle in the second ear portion for receiving a second earpiece. The set of over-the-ear headphones may further include a first connector in the first receptacle in the first ear portion for connecting to a first corresponding connector in the first earpiece and a second connector in the second receptacle in the second ear portion for connecting to a second corresponding connector in the second ear piece. The first connector may be configured to recharge a first battery in the first earpiece and wherein the second connector may be configured to recharge as second battery in the second earpiece. The set of over-the-ear headphones may further include a wireless transceiver for receiving an audio signal to reproduce at a first speaker associated with the first ear portion and a second speaker associated with the second ear portion. The set of over-the-ear headphones may include at least one sensor.

According to another aspect a method includes physically connecting a set of wireless earpieces or hearing aids with a set of over-the-ear headphones and charging the set of wireless earpieces or hearing aids while physically connected with the set of over-the-ear headphones. The method may further include transferring data between the set of wireless earpieces or hearing aids and the set of over-the-ear headphones while physically connected. The data may be sensor data collected with sensors of the over-the-ear headphones. The data may include a file. The method may further include transferring an audio signal between the set of wireless earpieces or hearing aids and the set of over-the-ear headphones while physically connected. The audio signal may provide streamed music from the wireless earpieces.

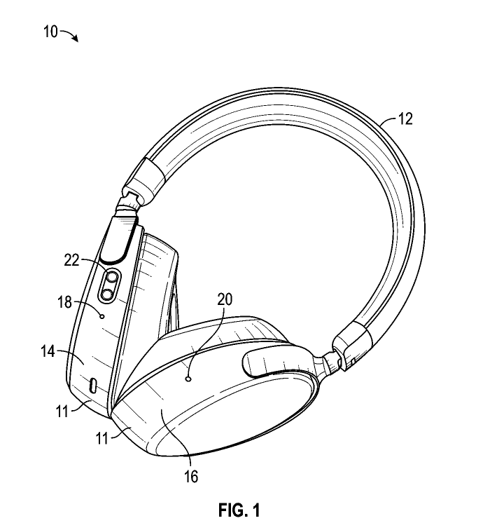

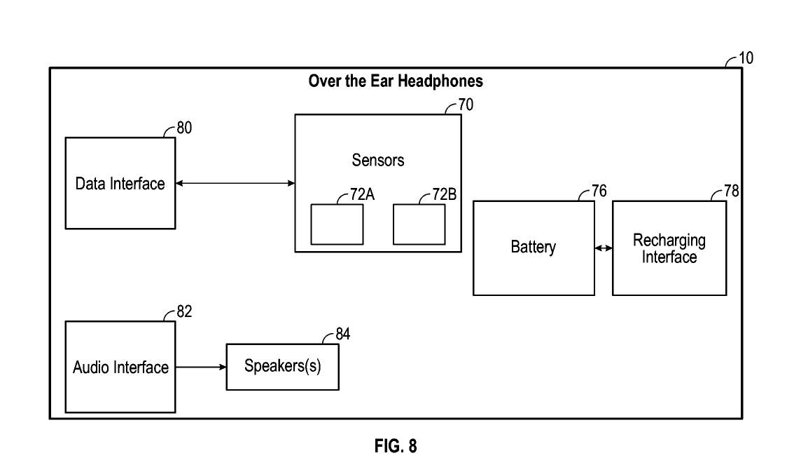

FIG. 1 illustrates one embodiment of a headphone 10. The headphone 10 has a left ear portion 14 having at least one microphone 18 and at least one speaker 84 (FIG. 8) associated therewith. The headphone 10 further includes a right ear portion 16 having at least one microphone 20 and at least one speaker 84 (FIG. 8) associated therewith. There is a connecting band 12 between the left ear portion 14 and the right ear portion 16. Various components are disposed within the headphone 10 (in the left ear potion 14, right ear portion 16, and/or the connecting band 12). In some embodiments, this can include cell phone circuitry including a cellular transceiver, one or more wireless transceivers such as a Bluetooth or BLE transceiver and/or a Wi-Fi transceiver, one or more processors, sensors, and other components. A camera module 22 is shown which may include a flash. It is to be understood however, more than one camera module 22 may be present on one or both, or all the left ear potion 14, the right ear portion 16, and the connecting band 12. A left hard exterior surface may be positioned at an exterior portion of the left ear portion 14. A right hard exterior surface may be positioned at an exterior portion of the right ear portion 16. Optical detectors may be placed at these surfaces to detect touches by a user. These optical detectors can be located on the headphones 10 or on the wireless earpieces 142 which sit inside of headphones 10. Alternatively, capacitive touch sensors may be used. Touch sensors of any kind may form a portion of a gestural interface receiving gestures from the user at the left hard exterior surface and the right hard exterior surface using optical detectors or these touch sensors can be located on the wireless earpieces 142 discussed in greater detail below. These gestures may include taps, holds, swipes, or other types of gestures. Any number of other sensors shown or described throughout may be positioned on one or more of the left ear portion 14, right ear portion 16, or connecting band 12.

Left 14 and right 16 ear portions have a housing 11. The housing 11 composed of plastic, metallic, nonmetallic or any material or combination of materials having substantial deformation resistance to facilitate energy transfer if a sudden force is applied to the left or right ear portions 14 & 16. For example, if headphone 10 is dropped by a user, the housing 11 may transfer the energy received from the surface impact throughout the entire headphone 10. In addition, the housing 11 may be capable of a degree of flexibility to facilitate energy absorbance if one or more forces is applied to the headphone 10. For example, if an object is dropped on the headphone 10, the housing 11 may bend to absorb the energy from the impact so the components within the headphone 10 are not substantially damaged. The flexibility of the housing 11 should not, however, be flexible to the point where one or more components of the headphone 10 may become non-functional if one or more forces are applied to the headphone 10.

Microphones 18 & 20 are operably coupled to the housing 11 and the speaker 84 and are positioned to receive ambient sounds. The ambient sounds may originate from an object worn or carried by a user, from the wireless earpieces 142, a third party or the environment. Environmental sounds may include natural sounds such as thunder, rain, or wind or artificial sounds such as sounds made by machinery at a construction site. The type of microphones 18 & 20 employed may be a directional, bidirectional, omnidirectional, cardioid, shotgun, or one or more combinations of microphone types, and more than one microphone may be present in the headphone 10. If more than one microphone is employed, each microphone 18 & 20 may be arranged in any configuration conducive to receiving an ambient sound. In addition, each microphone 18 & 20 may comprise an amplifier and/or an attenuator configured to modify sounds by either a fixed factor or in accordance with one or more user settings of an algorithm stored within a memory or the processor 38 of the headphone 10. For example, a user may issue a voice command to the wireless earphones 142 via the microphones 18 & 20 to instruct the wireless earphones 142 to amplify sounds having sound profiles substantially like a human voice and attenuate sounds exceeding a certain sound intensity. The user may also modify the user settings of the wireless earphones 142 using a voice command received by one of the microphones 18 & 20, a control panel or gestural interface on the wireless earpieces 142, or a software application stored on an external electronic device such as a mobile phone or a tablet capable of interfacing with the wireless earphone 142. Sounds may also be amplified or attenuated by an amplifier or an attenuator operably coupled to the headphone 10 and separate from the microphones 18 & 20 before being communicated to the speaker(s) 84 for sound processing.

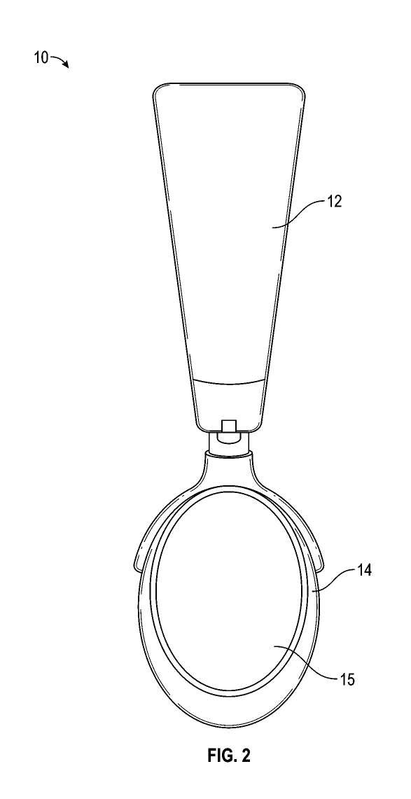

FIG. 2 illustrates a profile view of a set of over-the-ear headphones 10. The over-the-ear headphones 10 have a connecting band 12 spanning between a left ear side 14 and a right ear side 16. In one mode of operation, the over-the-ear headphones 10 function in a conventional manner for over-the-ear headphones. The over-the-ear headphones 10 may receive an audio signal either through a wired or wireless connection. A left ear portion 14 is shown. A cover 15 is also shown.

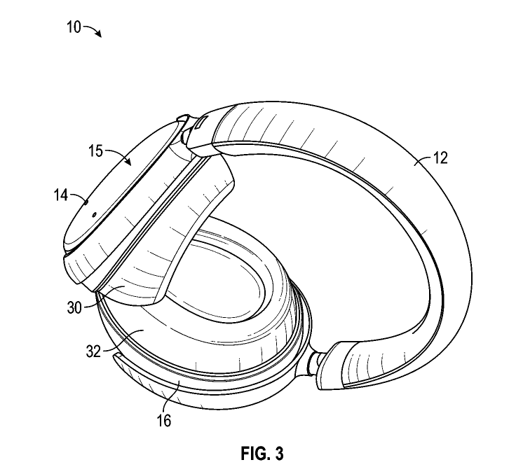

FIG. 3 illustrates another view of the headphones 10 with a left ear cushion 30 and a right ear cushion 32. The left ear cushion 30 may be positioned on an interior portion of the left ear portion 14 and the right ear cushion 32 may be positioned on an interior portion of the right ear portion 16.

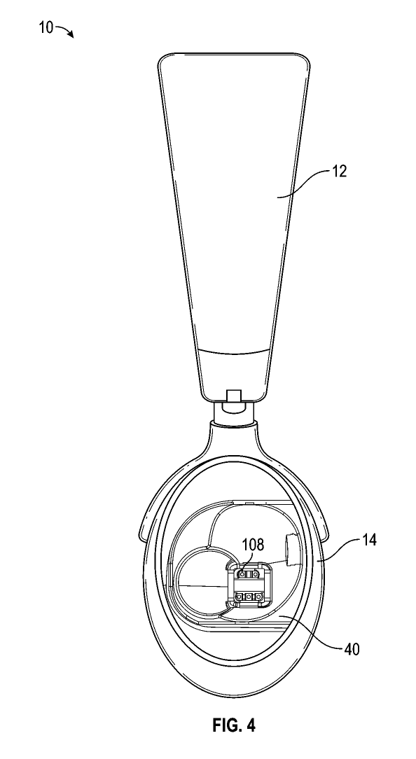

FIG. 4 illustrates the set of over-the-ear headphones 10 with the cover 15 removed. An earpiece receptacle 40 is shown within the first ear portion 14. A connector 108 is positioned within the earpiece receptacle 40. The earpiece receptacle 40 is sized and shaped to receive an earpiece. The connector 108 is configured to mate with a connector (contact sensors 206) on an earpiece 142 being received into the earpiece receptacle 40. The connector 108 may provide a charging interface to allow the earpiece 142 to be charged through the over-the-ear-headphones 10. The connector 108 may also include one or more data connections or signal connections as well.

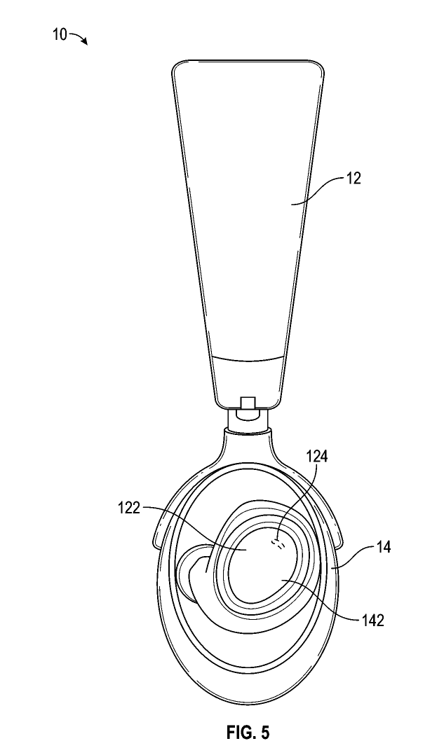

Turning now to FIGS. 4-5, these figures show a pictorial representation of over-the-ear-headphones 10 and wireless earpieces 142 in accordance with an illustrative embodiment. The headphones 10 may be an open (FIGS. 4&5) or enclosed case (FIGS. 1, 2 & 3) left 14 or right ear portion 16 for securing, charging and managing the wireless earpieces 142. The wireless earpieces 142 may be referred to as a pair (wireless earpieces) or singularly (wireless earpiece). The description may also refer to components and functionality of each of the wireless earpieces 142 collectively or individually. In one embodiment, the wireless earpieces 142 include a set of left and right ear pieces configured to fit into a user's ears. The wireless earpieces 142 may be configured to play music or audio, receive and make phone calls or other communications, determine ambient environmental readings (e.g., temperature, altitude, location, speed, heading, etc.), read user biometrics and actions (e.g., heart rate, motion, sleeping, etc.).

The over-the-ear-headphones 10 may act as a logging tool for receiving information, data, or measurements made by the wireless earpieces 142. For example, the over-the-ear-headphones 10 may be worn by the user to download data from the wireless earpiece(s) 142 in real-time. As a result, the over-the-ear-headphones 10 may be utilized to store, charge, and synchronize data for the wireless earpieces 142 in any number of embodiments.

The over-the-ear-headphones 10 can enclose a battery, and various circuitry (not shown, discussed later). The battery of the over-the-ear-headphones 10 may be utilized to charge the wireless earpieces 142 through direct contact or wirelessly. As a result, the over-the-ear-headphones 10 may act as a custom charger for ensuring the proper power management and functionality of the wireless earpieces 142. For example, the battery of the over-the-ear-headphones 10 may be utilized to charge the wireless earpieces 142 any number of times before the over-the-ear-headphones 10 and corresponding battery may require charging. In one embodiment, the over-the-ear-headphones 10 may include one or more solar panels, or surfaces configured to charge the over-the-ear-headphones 10 utilizing ambient or direct sunlight. The over-the-ear-headphones 10 ensure the duty cycle of the wireless earpieces 142 are maximized by properly maintaining power levels. For example, the over-the-ear-headphones 10 may keep the wireless earpieces 142 fully charged during a time of inactivity, such as before being purchased (e.g., on a shelf or as part of inventor) or when purchased.

In one embodiment, the over-the-ear-headphones 10 include a housing 11. The housing 11 is a support structure for the components of the over-the-ear-headphones 10 and may be formed of a rigid plastic, polymer, or other similar material. However, any number of other suitable materials, such as composites, rubber, wood, metal, or so forth, may be utilized. The housing 11 defines receptacle 40 configured to receive the wireless earpieces 142 respectively. In one embodiment, the receptacle 40 is shaped to fit the external size, shape, and configuration of the wireless earpieces 142.

As a result, an interference fit may secure the wireless earpieces 142 within the housing 11 while the over-the-ear-headphones 10 are being moved or otherwise utilized. In one embodiment, the over-the-ear-headphones 10 may include a hinged, magnetic, sleeve, or snap on lid or cover 15 covering the wireless earpieces 142 when positioned within the receptacle 40 of the over-the-ear-headphones 10. For example, the cover may make the over-the-ear-headphones 10 waterproof and further secure the wireless earpieces 142. In another embodiment, the over-the-ear-headphones 10 may also include a removable cover 15 (e.g., neoprene, zip up, snapping, etc.).

In yet another embodiment, the cover 15 encases a screen, such as a touch screen. The screen may roll, bend or adapt to the shape and configuration of the over-the-ear-headphones 10. The touch screen may also be transparent. In one embodiment, the over-the-ear-headphones 10 may be hermetically sealed and waterproof when the cover 15 is secured. The over-the-ear-headphones 10 may also include one or more speakers for playing music, indicating a status of the wireless earpieces 142 or otherwise communicating information to the user. Likewise, actuators may be utilized to provide tactile feedback to the user.

The headphones 10 include connectors 108 within the receptacles 40. The connectors 108 are hardware connectors for electrically connecting the wireless earpieces 142 to the over-the-ear-headphones 10. The connectors 108 may include any number of contact points, busses, wires, or other physical connectors for interfacing the wireless earpieces 142 with the over-the-ear-headphones 10. The connectors 108 may alternatively include inductive chargers for charging the wireless earpieces 142. In another embodiment, the connectors 108 may represent male (or alternatively female) connectors for interfacing with the wireless earpieces 142 such as micro-USB, or other developing miniature external connectors. The connectors 108 may be utilized to charge the wireless earpieces 142. The connectors 108 may also be utilized to synchronize data between the wireless earpieces 142. As previously noted, wireless charging is also contemplated utilizing an inductive charger integrated in the over-the-ear-headphones 10 or other charging devices compatible with the wireless earpieces 142.

In one embodiment, the connectors 108 may power off one or initiate a low power state or mode for one or both wireless earpieces 142 when one or more of the wireless earpieces 142 are placed within the receptacles 40. For example, a battery of the over-the-ear-headphones 10 may power the wireless earpieces 142 when positioned within the over-the-ear-headphones 10. As a result, minimal functionality is maintained while power requirements of the wireless earpieces 142 are passed to the over-the-ear-headphones 10.

In another embodiment, the wireless earpieces 142 and the over-the-ear-headphones 10 may interact to control a device reset function. For example, the wireless earpieces 142 may synchronize captured data with the over-the-ear-headphones 10 before moving to a low power mode in anticipation of being charged. A switch may be activated mechanically, magnetically, inductively, electrically, or wirelessly in anticipation of being charged. For example, the over-the-ear-headphones 10 may lower the power mode of the wireless earpieces 142 in response to contacts of the wireless earpieces 142 encountering the connectors 108. For example, the over-the-ear-headphones 10 may detect a change in resistance when the wireless earpieces 142 are electrically connected to the connectors 108 to perform the processes herein described. In another embodiment, each of the connectors 108 may include a switch activated when one of the wireless earpieces 142 is positioned within the receptacles 40. The connectors 108 may also include a pin when depressed or contacted by one of the wireless earpieces 142 turning off the wireless earpieces 142. Control of the wireless earpieces 142 may be controlled by the over-the-ear-headphones 10, the wireless earpieces 142 themselves, or may be shared between devices.

In one embodiment, the connectors 108 or another portion of the over-the-ear-headphones 10 as well as the wireless earpieces 142 may include a near field communication (NFC) chip for communications. For example, NFCs may determine the wireless earpieces 142 are proximate the over-the-ear-headphones 10 for performing power management. NFC may also be utilized to identify the wireless earpieces 142 associated with over-the-ear-headphones 10. In other embodiments, different communications protocols (e.g., Bluetooth, Wi-Fi, etc.), standards, or passive readers (radio frequency identification tags, etc.) may be utilized for the wireless earpieces 142 to communicate with the over-the-ear-headphones 10. For example, the over-the-ear-headphones 10 may power off the wireless earpieces 142 in response to being placed in or near the over-the-ear-headphones 10. The over-the-ear-headphones 10 may be programmed with a threshold distance (e.g., 10 cm, 1 foot, etc.) to determine when the wireless earpieces 142 are proximate the over-the-ear-headphones 10 or may rely on the inherent maximum communications distances of the wireless standard or protocol being utilized (e.g., NFC, RFID, etc.).

In another embodiment, biometric readings, such as heart beat or temperature may be utilized by the wireless earpieces 142 and over-the-ear-headphones 10 to alter the power mode or status of the wireless earpieces 142 as well as the over-the-ear-headphones 10 (e.g., may be placed in a low power mode). For example, if the wireless earpieces 142 are near the over-the-ear-headphones 10 and no heart beat is detected, the over-the-ear-headphones 10 may send a command for the wireless earpieces 142 to enter a low power mode or state. In one embodiment, power to onboard sensory arrays may be terminated and only essential functions may remain on. For example, the low power mode allows charging of the wireless earpieces 142 and/or over-the-ear-headphones 10 and uploads/downloads to the wireless earpieces 142 while in the low power mode.

The over-the-ear-headphones 10 may also be configured to modify or tune the wireless earpieces 142, in one embodiment, the software utilized by the wireless earpieces 142 may be adjusted based on the characteristics of the user's voice and environment. In another embodiment, the receptacles 40 may utilize a solution, brushes, ultrasonic cleaning or a combination thereof to clean or sanitize all or portions of the wireless earpieces 142 to maintain functionality and optimal performance. For example, a cleaning solution may be periodically added to the over-the-ear-headphones 10 for circulation in the receptacles 40 when the wireless earpieces 142 are positioned. In one embodiment, the receptacles 40 may include a locking mechanism and releases for securing the wireless earpieces 142 in place.

FIG. 5 illustrates the set of over-the-ear headphones 10 with an earpiece 142 received into the earpiece receptacle 40 of the first ear portion 14 of the over-the-ear headphones 10. The earpiece 142 has an outside surface 122 which may be used for various purposes. For example, a touch interface may be present on the surface 122. The touch interface may be implemented optically through using one or more emitters and receivers. The touch interface may be implemented capacitively or otherwise. In addition, one or more sensors may be present. For example, a microphone 124 may be present. Any number of other sensors may be present in the earpiece 142. This may include one or more of an inertial sensor, a biometric sensor such as a pulse oximeter, temperature sensor, heart rate sensor, or other type of sensor.

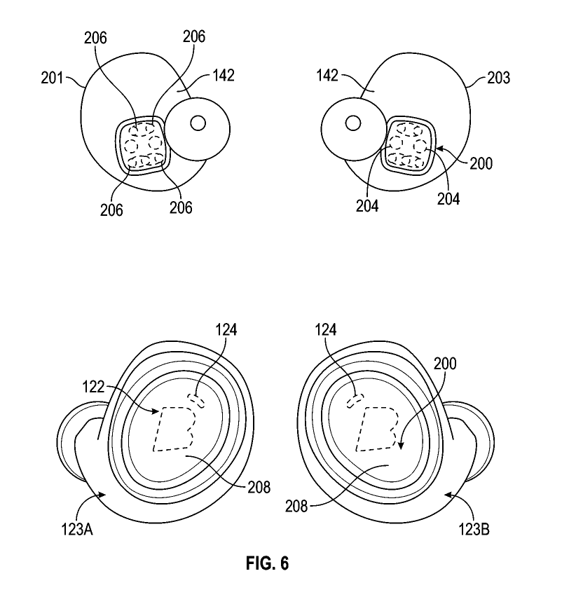

FIG. 6 illustrates a set of earpieces 142 which may be received into opposite ear portions of the over-the-ear headphones 10. The set of earpieces 142 include earpieces 201, 203 for opposite ears of an individual. Each of the earpieces 201, 203 includes an earpiece housing 123A, 123B. Each of the earpieces 201, 203 has a surface 122 which may function as a touch interface. Microphones 124A, 124B are also shown. Although as shown, the surface 122 of the wireless earpieces 201, 203 is exposed when interfaced with the headphones 10, it is contemplated in some embodiments, the surface need not be exposed, or other sensors need not be exposed.

As shown the wireless earpieces 142 may include a left wireless earpiece 201 and a right wireless earpiece 203 representative of a set of wireless earpieces. In other embodiments, a set of wireless earpieces may include several left wireless earpieces 201 and right wireless earpieces 203. The illustrative embodiments may also be applicable to large numbers of wireless earpieces and may communicate directly or indirectly (e.g., Wi-Fi, mesh networking, etc.) with each other via a wireless hub/wireless device or so forth.

As previously noted, the wireless earpieces 142 may include any number of internal or external sensors. In one embodiment, the sensors 200 may be utilized to determine environmental information and whether the wireless earpieces 142 are being utilized by different users. Similarly, any number of other components or features of the wireless earpieces 142 may be managed based on the measurements made by the sensors 200 to preserve resources (e.g., battery life, processing power, etc.). The sensors 200 may make independent measurements or combined measurements utilizing the sensory functionality of each of the sensors 200 to measure, confirm, or verify sensor measurements.

In one embodiment, the sensors 200 may include optical sensors 204, contact sensors 206, infrared sensors 208, and microphones 124. The optical sensors 204 may generate an optical signal communicated to the ear (or other body part) of the user and reflected. The reflected optical signal may be analyzed to determine blood pressure, pulse rate, pulse oximetry, vibrations, blood chemistry, and other information about the user. The optical sensors 204 may include any number of sources for outputting various wavelengths of electromagnetic radiation and visible light. Thus, the wireless earpieces 142 may utilize spectroscopy as it is known in the art and developing to determine any number of user biometrics.

The optical sensors 204 may also be configured to detect ambient light proximate the wireless earpieces 142. In one embodiment, the optical sensors 204 may also include an externally facing portion or components. For example, the optical sensors 204 may detect light and light changes in an environment of the wireless earpieces 142, such as in a room where the wireless earpieces 142 are located. The optical sensors 204 may be configured to detect any number of wavelengths including visible light relevant to light changes, approaching users or devices, and so forth. The optical sensors 204 may be configured to detect when wireless earpieces are located within receptacle(s) 40.

In another embodiment, the contact sensors 206 may be utilized to determine the wireless earpieces 142 are positioned within the ears of the user or within the receptacle(s) 40. For example, conductivity of skin or tissue within the user's ear may be utilized to determine the wireless earpieces are being worn. In other embodiments, the contact sensors 206 may include pressure switches, toggles, or other mechanical detection components for determining the wireless earpieces 142 are being worn or located within receptacle(s) 40. The contact sensors 206 may measure or provide additional data points and analysis indicating the biometric information of the user. The contact sensors 206 may also be utilized to apply electrical, vibrational, motion, or other input, impulses, or signals to the skin of the user. The contact sensors 206 may be internally or externally positioned. For example, external pushbuttons may be utilized to receive commands, instructions, or feedback related to the performance of the wireless earpieces 142.

The wireless earpieces 142 may also include infrared sensors 208. The infrared sensors 208 may be utilized to detect touch, contact, gestures, or another user input. The infrared sensors 208 may detect infrared wavelengths and signals. In another embodiment, the infrared sensors 208 may detect visible light or other wavelengths as well. The infrared sensors 208 may be configured to detect light or motion or changes in light or motion. Readings from the infrared sensors 208 and the optical sensors 204 may be configured to detect light or motion. For example, a hand gesture made in front of the wireless earpieces 202 may be detected and determined to be a command for an associated peripheral. The readings may be compared to verify or otherwise confirm light or motion. As a result, decisions regarding user input, biometric readings, environmental feedback, and other measurements effectively implemented in accordance with readings from the sensors 200 as well as other internal or external sensors and the user preferences. The infrared sensors 208 may also be integrated in the optical sensors 204.

The wireless earpieces 202 may include microphones 124. The microphones 124 may represent external microphones as well as internal microphones. The external microphones may be positioned exterior to the body of the user as worn. The external microphones may sense verbal or audio input, feedback, and commands received from the user. The external microphones may also sense environmental, activity, and external noises and sounds. The internal microphone may represent an ear-bone or bone conduction microphone. The internal microphone may sense vibrations, waves or sound communicated through the bones and tissue of the user's body (e.g., skull). The microphones 124 may sense content utilized by the wireless earpieces 142 to implement the processes, functions and methods herein described. The audio input sensed by the microphones 124 may be filtered, amplified or otherwise processed before or after being sent to the logic of the wireless earpieces 142. The processed user input from the microphones 124 may be processed to determine the command, associated peripheral, peripheral action and communications process for communicating the command to the peripheral.

In another embodiment, the wireless earpieces 142 may include chemical sensors (not shown) performing chemical analysis of the user's skin, excretions, blood or any number of internal or external tissues or samples. For example, the chemical sensors may determine whether the wireless earpieces 142 are being worn by the user. The chemical sensor may also be utilized to monitor important biometrics more effectively read utilizing chemical samples (e.g., sweat, blood, excretions, etc.). In one embodiment, the chemical sensors are non-invasive and may only perform chemical measurements and analysis based on the externally measured and detected factors. In other embodiments, one or more probes, vacuums, capillary action components, needles, or other micro-sampling components may be utilized. Minute amounts of blood or fluid may be analyzed to perform chemical analysis reported to the user and others. The sensors 200 may include parts or components periodically replaced or repaired to ensure accurate measurements. In one embodiment, the infrared sensors 208 may be a first sensor array and the optical sensors 204 may be a second sensor array.

In other embodiments, the wireless earpieces 142 may include radar or LIDAR sensors for mapping the user's ear, head, and body. The radar and/or LIDAR sensors may also measure and map an environment associated with the wireless earpieces 142 in real-time or near real-time. The transceivers of the wireless earpieces 142 may also act as a sensor for determining proximity of the wireless earpieces 142 to associated wireless devices, peripherals, other wireless earpieces, users and so forth. For example, signal strength, absorption, reflection, and so forth may be utilized to determine distances, orientation, and location of the wireless earpieces 142 as well as the external devices and objects as noted above.

Any of the sensors 200 of the wireless earpieces 142 may measure user input and commands utilized to control associated peripheral devices. The sensors may be utilized individually or in combination to most effectively detect and process commands from the user.

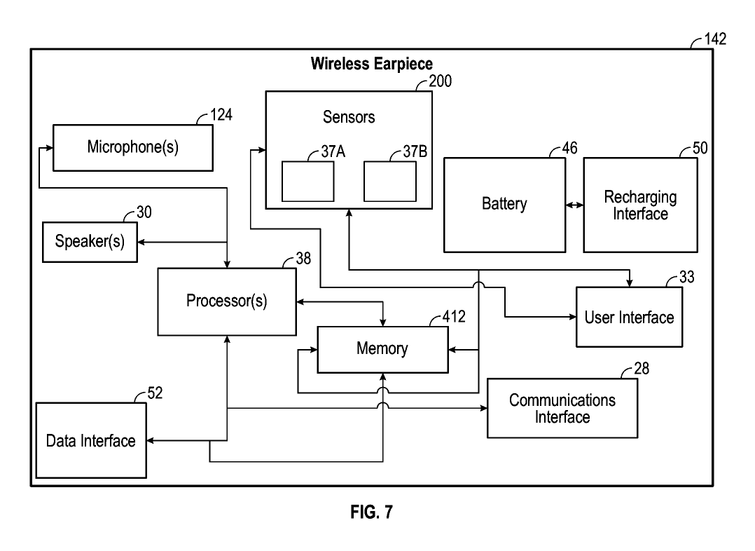

FIG. 7 is a block diagram of one example of a wireless earpiece 142. The wireless earpiece 142 includes one or more processors 38 which may include one or more digital signal processors or microcontrollers. One or more speakers 30 and one or more microphones 124 are operatively connected to the one or more processors 38. A user interface 33 is also operatively connected to the one or more processors 38. The user interface 33 may include a touch interface such as may be implemented using optical emitters or detectors. The user interface 33 may be a capacitive touch user interface, or other type of user interface. One or more sensors 200 are present. The sensors 200 may include biometric sensors 37A such as pulse oximeters, heart rate sensors, temperature sensors, chemical sensors, electrical resistance sensors, or other sensors which may be used to sense biometric information. The sensors 200 may also include inertial sensors 37B, or other types of sensors. A battery 46 is shown which is operatively connected to a recharging interface 50. The recharging interface 50 may be used to connect with the headphones 10 and allow for charging of the wireless earpieces 142. A communications interface 28 is also shown which may be used to provide wireless communications such as via radio transceiver, NFMI transceiver, or otherwise. A data interface 52 is also shown which is operatively connected to the one or more processors 38. The data interface may be connected to one or more physical connections from the over-the-ear headphones 10.

As previously noted, the wireless earpieces 142 may be referred to or described herein as a pair (wireless earpieces) or singularly (wireless earpiece). The description may also refer to components and functionality of each of the wireless earpieces 142 collectively or individually. In one embodiment, the headphone/wireless earpiece system 400 (FIG. 5) may enhance communications and functionality. In one embodiment, the headphone system 400 or wireless earpieces 142 may communicate directly or through one or more networks (e.g., Wi-Fi, mesh networks, cell networks, IoT network, Internet, etc.).

The wireless earpieces 142 may be wirelessly linked to the headphones 10. User input, commands, and communications may be received from either the wireless earpieces 142 or the headphones 10 for implementation on either of the devices of the headphone system 400 (or other externally connected devices). Communications between the wireless earpieces 402 and the headphones 10 may be unidirectional or bidirectional.

In some embodiments, the headphones 10 may act as a logging or ledger tool for receiving information, data, financial transactions, or measurements made by the wireless earpieces 142 together or separately. For example, the headphones 10 may receive or download biometric data from the wireless earpieces 142 in real-time for a user utilizing the wireless earpieces 142. As a result, the headphones 10 may be utilized to store, display, and synchronize data for the wireless earpieces 142 as well as manage communications. For example, the headphones 10 may display pulse, proximity, location, oxygenation, distance, calories burned, and so forth as measured by the wireless earpieces 142. The headphones 10 may be configured to receive and display an interface (e.g., touch screen, soft buttons, switches, toggles, physical buttons, etc.), selection elements, and alerts indicate conditions for sharing communications. For example, the wireless earpieces 142 may utilize factors, such as changes in motion or light, distance thresholds between the wireless earpieces 142 and/or headphones 10, signal activity, user orientation, user speed, user location, environmental factors (e.g., temperature, humidity, noise levels, proximity to other users, etc.) or other automatically determined or user specified measurements, factors, conditions, or parameters to implement various features, functions, and commands.

The headphones 10 may also include any number of optical sensors, touch sensors, microphones, and other measurement devices (sensors 70) providing feedback or measurements the wireless earpieces 142 may utilize to determine an appropriate mode, settings, or enabled functionality. The wireless earpieces 142 and the headphones 10 may have any number of electrical configurations, shapes, and colors and may include various circuitry, connections and other components.

In one embodiment, one or both wireless earpieces 142 may include a battery 46, a processor 38, a memory 412, a user interface 33, a data interface 52, a communications interface 28, and sensors 200. The headphones 10 may have any number of configurations and include components and features like the wireless earpieces 142 as are known in the art. The sharing functionality and logic implemented as part of the processor 38, user interface 33, or other hardware, software, or firmware of the wireless earpieces 142 and/or headphones 10.

The battery 46 is a power storage device configured to power the wireless earpieces 142. In other embodiments, the battery 46 may represent a fuel cell, thermal electric generator, piezo electric charger, solar units, thermal power generators, ultra-capacitor, or other existing or developing power generation and storage technologies. The processor 38 preserves the capacity of the battery 46 by reducing unnecessary utilization of the wireless earpieces 142 in a full-power mode when there is little or no benefit to the user (e.g., the wireless earpieces 142 are sitting on a table or temporarily lost). The battery 46 or power of the wireless earpieces 142 are preserved for when being worn or operated by the user. As a result, user satisfaction with the wireless earpieces 142 is improved and the user may be able to set the wireless earpieces 142 aside at any moment knowing battery life is automatically preserved by the processor 38 and functionality of the wireless earpieces 142. In addition, the battery 46 may use just enough power for the communications interface 28 for communicating across a distance separating users of the wireless earpieces 142.

The processor 38 is the logic controlling the operation and functionality of the wireless earpieces 142. The processor 38 may include circuitry, chips, and other digital logic. The processor 38 may also include programs, scripts, and instructions implemented to operate the processor 38. The processor 38 may represent hardware, software, firmware, or any combination thereof. In one embodiment, the processor 38 may include one or more processors. The processor 38 may also represent an application specific integrated circuit (ASIC) or field programmable gate array (FPGA). In one embodiment, the processor 38 may execute instructions to manage the wireless earpieces 142 including interactions with the components of the wireless earpieces 142, such as the user interface 33, communications interface 28, and sensors 200.

The processor 38 may utilize data and measurements from the communications interface 28 and sensors 200 to measure user input, determine distances between the wireless earpieces 142 and the headphones 10, and determine whether the wireless earpieces 142 are being utilized by different users. For example, distance, biometrics, user input, and other application information, data, and measurements may be utilized to determine whether a peripheral command is implemented by the processor 38 and other components of the wireless earpieces 142. The processor 38 may control actions implemented in response to any number of measurements from the sensors 200, the communications interface 28, the user interface 33, or the data interface 52 as well as user preferences may be user entered or other default preferences. For example, the processor 38 may initialize a peripheral management mode in response to any number of factors, conditions, parameters, measurements, data, values, or other information specified within the user preferences or logic. The processor 38 may control the various components of the wireless earpieces 142 to implement the peripheral management mode.

The processor 38 may implement any number of processes for the wireless earpieces 142, such as facilitating communications, listening to music, tracking biometrics or so forth. The wireless earpieces 142 may be configured to work together or completely independently based on the needs of the users. In one embodiment, each of the wireless earpieces 142 may not include all the components as shown. For example, only one of the wireless earpieces 142 may include a communications interface 28 for communicating with the headphones 10. In another example, the wireless earpieces 142 may not include sensors 200, but may instead utilize buttons, selectors, or other input devices included in the user interface 33 to control the management and operation of the wireless earpieces 142. The wireless earpieces 142 may also represent an integrated portion of headphones 10.

The processor 38 may also process user input to determine commands implemented by the wireless earpieces 142 or sent to the headphones 10 through the communications interface 28. Specific actions may be associated with user input (e.g., voice, tactile, orientation, motion, gesture, etc.). For example, the processor 38 may implement a macro allowing the user to associate frequently performed actions with specific commands/input implemented by the wireless earpieces 142. A training process or training mode may be utilized by the processor 38 to associate user input/commands with commands sent to the headphones 10. The user input may include a combination of factors, such as a voice input and head gesture/orientation. The user input may specify one or more inputs as well as biometrics utilized. In one embodiment, the wireless earpieces 142 may require the user is identified before processing any commands.

In one embodiment, the processor 38 is circuitry or logic enabled to control execution of a set of instructions. The processor 38 may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 412 is a hardware element, device, or recording media configured to store data or instructions for subsequent retrieval or access later. The memory 412 may represent static or dynamic memory. The memory 412 may include a hard disk, random access memory, cache, removable media drive, mass storage, or configuration suitable as storage for data, instructions, and information. In one embodiment, the memory 412 and the processor 38 may be integrated. The memory 412 may use any type of volatile or non-volatile storage techniques and mediums. The memory 412 may store information related to user input/commands, headphone actions associated with the commands, communications identifiers, authorizations, as well as the status of a user, wireless earpieces 402, headphones 10, and other peripherals, such as a tablet, smart glasses, a smart watch, a smart case for the wireless earpieces 142, a wearable device, and so forth. In one embodiment, the memory 412 may display instructions, programs, drivers, or an operating system for controlling the user interface 33 including one or more LEDs or other light emitting components, speakers, tactile generators (e.g., vibrator), and so forth. The memory 412 may also store thresholds, conditions, signal or processing activity, proximity data, and so forth.

The communications interface 28 are components including both a transmitter and receiver which may be combined and share common circuitry on a single housing. The communications interface 28 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. In one embodiment, the communications interface 28 may represent a hybrid or multi-mode transceiver supporting several different communications with distinct devices simultaneously. For example, the communications interface 28 may communicate with the headphones 10 or other systems utilizing wired interfaces (e.g., wires, traces, etc.), NFC, or Bluetooth communications as well as inter-device between the wireless earpiece 142 utilizing NFMI. The communications interface 28 may also detect amplitudes and signal strength to infer distance, directions, orientation, and positions with respect to the wireless earpieces 142 as well as the headphones 10. For example, commands may only be sent from the wireless earpieces 142 if the headphones 10 are within range or able to receive the command from the wireless earpieces 142.

The components of the wireless earpieces 142 may be electrically connected utilizing any number of wires, contact points, leads, busses, wireless interfaces or so forth. In addition, the wireless earpieces 142 may include any number of computing and communications components, devices or elements which may include busses, motherboards, printed circuit boards, circuits, chips, sensors, ports, interfaces, cards, converters, adapters, connections, transceivers, displays, antennas and other similar components. The data interface 52 is hardware interface of the wireless earpieces 142 for connecting and communicating with the headphones 10 or other electrical components, devices, or systems.

The data interface 52 may include any number of pins, arms, or connectors for electrically interfacing with the contacts or other interface components of external devices or other charging or synchronization devices. For example, the data interface 52 may be a micro USB port. In one embodiment, the data interface 52 is a magnetic interface automatically coupling to contacts or an interface of the headphones 10. In another embodiment, the data interface 52 may include a wireless inductor for charging the wireless earpieces 142 without a physical connection to a charging device. In addition, the data interface 52 may be utilized to synchronize, link, or connect the wireless earpieces 142 with the headphones 10 for sending and receiving commands, communications, and content as well as implementing the associated peripheral actions.

The data interface 52 may allow the wireless earpieces 142 to be utilized when not worn as a remote microphone and sensor system (e.g., seismometer, thermometer, light detection unit, motion detector, etc.). For example, measurements, such as noise levels, temperature, movement, and so forth may be detected by the wireless earpieces 142 even when not worn. The wireless earpieces 142 may be utilized as a pair, independently or when stored in the headphones 10. Each of the wireless earpieces 142 may provide distinct sensor measurements as needed. In one embodiment, the headphones 10 may include hardware (e.g., logic, battery, transceiver, etc.) to integrate as part of a mesh network, repeater, router, or extender. For example, the headphones 10 may be utilized as a node or relay within a mesh network for sending and receiving communications, such as peripheral commands.

The user interface 33 is a hardware interface for receiving commands, instructions, or input through the touch (haptics) of the user, voice commands or predefined motions. The user interface 33 may further include any number of software and firmware components for interfacing with the user. The user interface 33 may be utilized to manage and otherwise control the other functions of the wireless earpieces 142 including mesh communications. The user interface 33 may include the LED array, one or more touch sensitive buttons or portions, a miniature screen or display or other input/output components (e.g., the user interface 33 may interact with the sensors 200 extensively). The user interface 33 may be controlled by the user or based on commands received from the headphones 10 or a linked wireless device. In one embodiment, peripheral management modes and processes may be controlled by the user interface, such as recording communications, receiving user input for communications, sharing biometrics, queuing communications, sending communications, receiving user preferences for the communications and so forth. The user interface 33 may also include a virtual assistant for managing the features, functions and components of the wireless earpieces 142.

In one embodiment, the user may provide user input for the user interface 33 by tapping a touch screen or capacitive sensor once, twice, three times, or any number of times. Similarly, a swiping motion may be utilized across or in front of the user interface 33 (e.g., the exterior surface of the wireless earpieces 142) to implement a predefined action. Swiping motions in any number of directions or gestures may be associated with specific activities or actions of the wireless earpieces 142 (or the headphones 10), such as play music, pause, fast forward, rewind, activate a virtual assistant, listen for commands, initiate fitness tracking, take a picture, stop recording, activate biometric tracking, send automated messages, control appliances, report biometrics, enabled sharing communications, and so forth.

As previously noted, the swiping motions may be similarly utilized to control actions and functionality of the headphones 10 or other external peripheral devices (e.g., smart television, camera array, smart watch, vehicle systems, displays, processing systems, etc.). The user may also provide user input by moving his head in a direction or motion or based on the user's position or location. For example, the user may utilize voice commands, head gestures, or touch commands to change the processes implemented by the wireless earpieces 142 as well as the processes executed, or content displayed by the headphones 10. The user interface 33 may also provide a software interface including any number of icons, soft buttons, windows, menus, windows, links, graphical display units, and so forth.

In one embodiment, the sensors 200 may be integrated with the user interface 33 to detect or measure the user input. For example, infrared sensors positioned against an outer surface of the wireless earpieces 142 may detect touches, gestures, or other input as part of a touch or gesture sensitive portion of the user interface 33. The outer or exterior surface of the user interface 33 may correspond to a portion of the wireless earpieces 142 accessible to the user when the wireless earpieces 142 are worn within the ears of the user.

In addition, the sensors 200 may include biometric sensors 37A and inertial sensors 37B: pulse oximeters, accelerometers, thermometers, barometers, radiation detectors, gyroscopes, magnetometers, global positioning systems, beacon detectors, inertial sensors, photo detectors, miniature cameras, and other similar instruments for detecting user biometrics, environmental conditions, location, utilization, orientation, motion, and so forth. The sensors 200 may provide measurements or data utilized to select, activate or otherwise utilize the network. Likewise, the sensors 200 may be utilized to awake, activate, initiate or otherwise implement actions and processes utilizing conditions, parameters, values or other data within the user preferences. For example, the optical biosensors 204 within the sensors 200 may determine whether the wireless earpieces 142 are being worn and when a selected gesture to activate a peripheral action is provided by the user.

FIG. 8 is a block diagram of one example of a set of over-the-ear headphones 10. The over-the-ear headphones 10 may be “dumb” in the sense no processor is needed. The set of over-the-ear headphones 10 may include a battery 76 (although it need not include a battery if they are wired). A recharging interface 78 is shown which may be used to recharge batteries of wireless earpieces which are received into the set of over-the-ear headphones 10. One or more sensors 70 may be present. Any number of different sensors may include microphones 18 & 20, biometric sensors 72A, imaging sensors 72B, or other types of sensors. A data interface 80 is also shown which may be used to communicate sensor data from the sensors 70 to the wireless earpiece 142. An audio interface 82 is shown which allows for receiving audio. In some embodiments the audio interface 82 may be a wired interface. In other embodiments, the audio interface 82 may be a wireless interface. The audio interface 82 may be operatively connected to one or more speakers 84 for reproducing the audio at each ear.

It is to be understood various benefits may be achieved by interfacing the wireless earpieces 142 with the over-the-ear headphones 10. As an initial matter, ear pieces such as ear bud style earpieces 142 are generally small with little available space for batteries. Therefore, the life of batteries is limited. Over-the-ear headphones 10 are larger with more opportunity to include batteries. Therefore, it may be advantageous to allow over-the-earphones 10 to charge the earpiece 142. In addition, over-the-ear headphones 10 may also be wired. In one embodiment, the over-the-ear headphones 10 have a wired USB connection which provides power which can be used to charge the earpieces 142 when received into the over-the-ear headphones 10. In addition, data may be transmitted from the earpieces 142 to a computing device operatively connected via USB with the headphones 10.

Another benefit of the over-the-ear headphones 10 is the over-the-ear headphones 10 need not be sophisticated in terms of onboard electronics. Instead, functionality of the wireless earpieces 142 is used instead. For example, instead of having processors within the over-the ear headphones 10, processors may be placed within the wireless earpieces 142. A given user may either wear the earpieces 142, wear the over-the-ear headphones 10 without the earpieces 142 in a conventional manner, or wear the over-the-ear headphones 10 with the earpieces 142 when wanting to take advantage of added functionalities provided by the combination or to charge the wireless earpieces 142 while still using them.

The headphones 10 may include additional sensors such as imaging sensors 72B placed around the headband 12, additional microphones, or other biometric sensors 72A. These sensors 70 on the headphones 10 may then be connected through data connections so this data is received by one or both wireless earpieces 142. Thus, the headphones 10 may serve a useful function in providing the ability to include additional sensors 70 which may not comfortably fit within the earpieces 142 or which may be better positioned with respect to a user. For example, a centrally mounted image sensor 72A may be present on the headband 12 to provide a forward-looking view or backward-looking view which is different from what is possible with the earpieces 142. Thus, it is advantageous to have additional sensors on the headphones.

The wireless earpieces 142 provide the intelligence, so the headphones 10 need not include sophisticated processing capabilities and need not have any at all. Thus, the wireless earpieces 142 may include Bluetooth transceivers or BLE transceivers, or other transceivers which allow for wireless streaming to the headphones 10. The headphones 10 may provide for an improved listening experience through a comfortable fit with ear cushions and larger speakers than is possible for the earpiece.

The headphones 10 may include additional storage as well. Because of limited space within the wireless earpieces 142, it is contemplated additional storage may be located within the headphone 10 and accessed by one or both wireless earpieces 142 when connected to the headphones 10.

According to another aspect, the wireless earpieces 142 may be hearing aids. Hearing aids are generally expensive devices with limited application. However, the hearing aids may be combined with the over-the-ear headphones 10 to provide an improved listening experience for the user. In addition, the over-the-ear headphones 10 may be used to charge the hearing aids.

Therefore, various embodiments have been shown and described for over-the-ear headphones 10 which are configured to interface with wireless earpieces 142 or hearing aids. It is to be understood numerous variations in the features and functionality of the wireless earpieces 142 or hearing aids and the over-the-ear headphones 10 are contemplated. Therefore, the present invention is not to be limited to the specific embodiments shown or described.

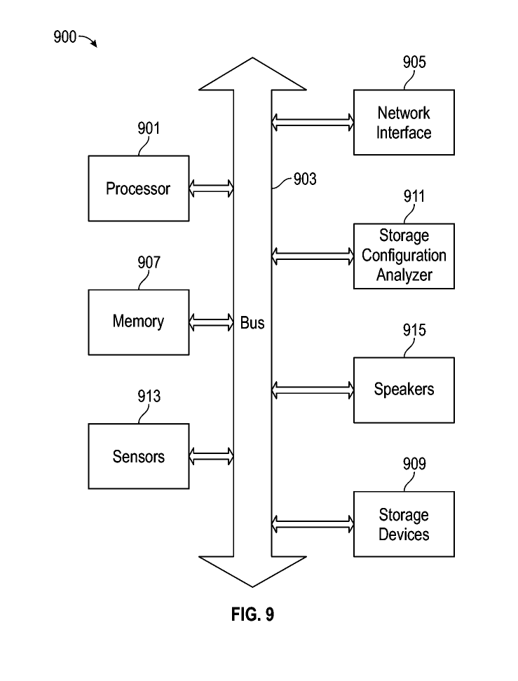

FIG. 9 depicts intelligent headphones 900 in accordance with an illustrative embodiment. For example, the intelligent headphones 900 may represent a device, such as the headphones 10 of FIGS. 1, 2, 3, 4 & 5. The intelligent headphones 900 include a processor unit 901 (possibly including multiple processors, multiple cores, multiple nodes, and/or implementing multi-threading, etc.). The intelligent headphones 900 include memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The intelligent headphones 900 also include a bus 903 (e.g., PCI, ISA, PCI-Express, HyperTransport®, InfiniBand®, NuBus, etc.), a network interface 906 (e.g., an ATM interface, an Ethernet interface, a Housing Relay interface, SONET interface, wireless interface, etc.), and a storage device(s) 909 (e.g., optical storage, magnetic storage, etc.).

The system memory 907 embodies functionality to implement all or portions of the embodiments described above. The system memory 907 may include one or more applications or sets of instructions for implementing a wireless earpiece 142 management mode with one or more wireless earpieces 142. In one embodiment, specialized wireless earpiece management software may be stored in the system memory 907 and executed by the processor unit 902. The wireless earpiece management software may be utilized to manage user preferences (e.g., settings, automated processes, etc.), communications, input, and device actions, synchronize devices, or so forth. As noted, the management application or software may be similar or distinct from the application or software utilized by the wireless earpieces 142. Code may be implemented in any of the other devices of the intelligent headphones 900. Any one of these functionalities may be partially (or entirely) implemented in hardware and/or on the processing unit 901. For example, the functionality may be implemented with an application specific integrated circuit, in logic implemented in the processing unit 901, in a co-processor on a peripheral device or card, etc.

Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901. The computing system 900 may further include any number of sensors 913, such as optical sensors, accelerometers, magnetometers, microphones, gyroscopes, temperature sensors, and so forth for verifying user biometrics, or environmental conditions, such as motion, light, or other events associated with the wireless earpieces or their environment.

The illustrative embodiments may be utilized to control and manage content (e.g., audio, video, data, etc.) played, displayed, or communicated by one or more wireless earpieces 142 as managed through the wireless earpieces 142. For example, music may be streamed from the wireless earpieces 142 to one or more wireless speakers 915 whether directly or through an intermediary device (e.g., smart phone, repeater, etc.). For example, the wireless earpieces 142 may control a smart phone synchronized with a Bluetooth speaker. In one embodiment, the wireless earpieces 142 may automatically connect to intelligent headphones 900. For example, the wireless earpieces 142 and the intelligent headphones 900 may have been previously paired. In another embodiment, the wireless earpieces 142 may connect to intelligent headphones 900 based on user input, feedback, or instructions, such as a directional gesture, voice command, head motion, or so forth. The wireless earpieces 142 may be linked, connected, or paired (or disconnected, unpaired) in real-time based on user input.

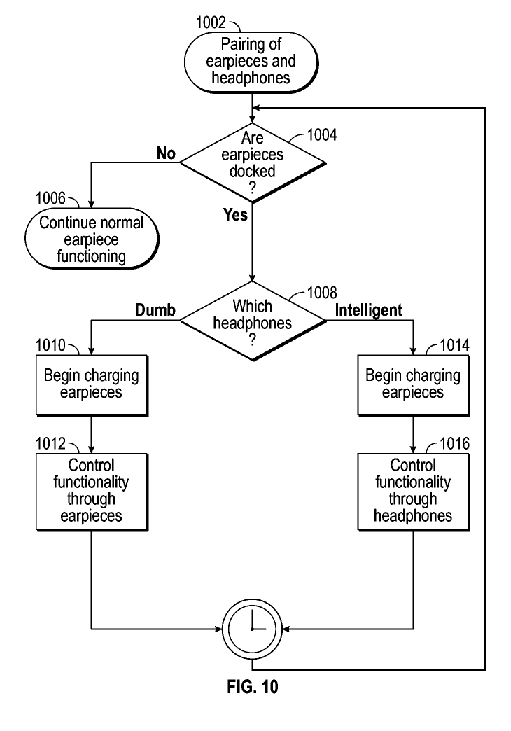

FIG. 10 shows a flowchart of operation between a wireless earpiece(s) and over-the-ear headphones in accordance with an illustrative embodiment. The interoperation process 1000 between wireless earpieces 142 and over-the-ear headphones 10, 900 is shown starting at state 1002 where the earpieces 142 and headphones 10, 900 are paired. At state 1004, wireless earpieces 142 determine whether they are docked within earpiece receptacle 40. At state 1006, wireless earpieces 142 continue to operate normally with the user directly operating and controlling the functioning of the wireless earpieces 142 if they are not docked within the headphones 10, 900. If the wireless earpieces 142 are docked or are within a range where operational control of the wireless earpieces can be assumed by headphones 10, 900, then at state 1008 wireless earpieces determine which headphones 10, 900 the wireless earpieces are docked with; dumb headphones 10 or intelligent headphones 900.

If the headphones 10, 900 are dumb, then at state 1010, headphones 10 begin to charge wireless earpieces 142 after a brief period of synchronization, as discussed in detail above. Then at state 1012, wireless earpieces 142 will assume operational control of both wireless earpiece 142 and headphone 10 routing all audio through to speakers 84 and receiving input from sensors 70 onboard headphones 10.

If the headphones 10, 900 are intelligent, then at state 1014, headphones 900 begin to charge wireless earpieces 142 after a brief period of synchronization. Intelligent headphones 900 will then assume all functionality at state 1016 and instruct wireless earpieces to a low-power mode unless otherwise needed.

Periodically, interoperation process 1000 will proceed to state 1004 to determine if the wireless earpieces are still docked or not and then proceed accordingly and iteratively.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

Although various embodiments have been shown and described herein, the present invention contemplates numerous alternatives, options, and variations. This may include variations in the number or types of processors, variations in the size, shape, and style of the hearing aid, variations in the number of speakers, variations in the number of microphones, variations in the types of files stored within the device, and other variations.

What is claimed is:

1. A set of over-the-ear headphones configured for receiving earpieces, the set of over-the-ear headphones comprising:
a first ear portion;
a second ear portion;
a headband spanning between the first ear portion and the second ear portion;
a first receptacle in the first ear portion for receiving a first earpiece; and
a second receptacle in the second ear portion for receiving a second earpiece.

2. The set of over-the-ear headphones of claim 1 further comprising a first connector in the first receptacle in the first ear portion for connecting to a first corresponding connector in the first earpiece and a second connector in the second receptacle in the second ear portion for connecting to a second corresponding connector in the second ear piece.

3. The set of over-the-ear headphones of claim 2 wherein the first connector is configured to recharge a first battery in the first earpiece and wherein the second connector is configured to recharge as second battery in the second earpiece.

4. The set of over-the-ear headphones of claim 1 wherein the set of over-the-ear headphones comprises a wireless transceiver for receiving an audio signal to reproduce at a first speaker associated with the first ear portion and a second speaker associated with the second ear portion.

5. The set of over-the-ear headphones of claim 4 wherein the set of over-the-ear headphones comprises at least one sensor.

6. A method comprising the steps of:
physically connecting a set of wireless earpieces or hearing aids with a set of over-the-ear headphones;
charging the set of wireless earpieces or hearing aids while physically connected with the set of over-the-ear headphones.

7. The method of claim 6 further comprising the step of transferring data between the set of wireless earpieces or hearing aids and the set of over-the-ear headphones while physically connected.

8. The method of claim 7 wherein the data comprises sensor data collected with sensors of the over-the-ear headphones.

9. The method of claim 7 wherein the data comprises a file.

10. The method of claim 6 further comprising the step of transferring an audio signal between the set of wireless earpieces or hearing aids and the set of over-the-ear headphones while physically connected.

11. The method of claim 10 wherein the audio signal is a streaming signal.

12. A set of over-the-ear headphones configured for receiving earpieces, the set of over-the-ear headphones comprising:
a first ear portion;
a second ear portion;
a headband spanning between the first ear portion and the second ear portion;
a first receptacle in the first ear portion for receiving a first hearing aid; and
a second receptacle in the second ear portion for receiving a second hearing aid.

13. The set of over-the-ear headphones of claim 12 further comprising a first connector in the first receptacle in the first ear portion for connecting to a first corresponding connector in the first hearing aid and a second connector in the second receptacle in the second ear portion for connecting to a second corresponding connector in the second hearing aid.

14. The set of over-the-ear headphones of claim 13 wherein the first connector is configured to recharge a first battery in the first hearing aid and wherein the second connector is configured to recharge as second battery in the second hearing aid.

15. The set of over-the-ear headphones of claim 12 wherein the set of over-the-ear headphones comprises a wireless transceiver for receiving an audio signal to reproduce at a first speaker associated with the first ear portion and a second speaker associated with the second ear portion.

16. The set of over-the-ear headphones of claim 15 wherein the set of over-the-ear headphones comprises at least one sensor.

17. The set of over-the-ear headphones of claim 12, further comprising a cover removable coupled to fit over the first receptacle.

18. The set of over-the-ear headphones of claim 17 wherein the first receptacle is sized and shaped to receive the first hearing aid.

19. The set of over-the-ear headphones of claim 18, further comprising a processor.

20. The set of over-the ear headphones of claim 19, further comprising a recharging interface.
